(19) United States
(12) Patent Application Publication
(10) Pub. No.: US 2025/0162523 A1
(43) Pub. Date: May 22, 2025

(54) MANUFACTURING METHOD OF SOUNDPROOF CUSHIONING MATERIAL AND SOUNDPROOF CUSHIONING MATERIAL

(71) Applicant: SANKO GOSEI LTD., Nanto-shi (JP)

(72) Inventors: Yoshiaki NAOI, Nanto-shi (JP); Keiichi OOKA, Nanto-shi (JP); Mototada FUTATSUKA, Nanto-shi (JP)

(73) Assignee: SANKO GOSEI LTD., Nanto-shi (JP)

(21) Appl. No.: 19/029,321

(22) Filed: Jan. 17, 2025

Related U.S. Application Data
(62) Division of application No. 17/588,951, filed on Jan. 31, 2022.

(30) Foreign Application Priority Data
Mar. 12, 2021 (JP) 2021-40038

(51) Int. Cl. B60R 13/08

(52) U.S. Cl. CPC B60R 13/0861

(57) ABSTRACT

A soundproof cushioning material to be attached to an inner face of a wheel well of a vehicle body, including: a soundproof cushioning area, in which a non-woven fabric having a large number of short fibers entangled with each other is disposed; and a continuous resin area defining a continuous face with the soundproof cushioning area with a boundary part intervening therebetween. Also disclosed is a method for manufacturing the soundproof cushioning material.

### CROSS-REFERENCE TO RELATED APPLICATIONS

This application is a Divisional Application of U.S. application Ser. No. 17/588,951, filed on Jan. 31, 2022, which is based on and claims priority to Japanese Patent Application No. 2021-40038, filed on Mar. 12, 2021, in the Japanese Intellectual Property Office, the disclosures of which are incorporated by reference herein in their entireties.

### BACKGROUND OF THE INVENTION

### Field of the Invention

The present invention relates to a manufacturing method of soundproof cushioning material and a soundproof cushioning material that is attached to the inner face of the wheel well of a vehicle body. The cushioning material absorbs the impact of foreign objects such as pebbles that are bounced up when the vehicle is running and collide with the vehicle body, suppresses impact noise, and inhibits damage to the vehicle body near the tires.

### Background Art

Patent Document 1, for example, discloses a soundproof cushioning material (fender liner) including a non-woven fabric in which a large number of short fibers are entangled with each other. Such a soundproof cushioning material made of non-woven fabric has excellent impact resistance and soundproofing properties (particularly sound absorbing properties) because a myriad of voids formed between the fibers entangled with each other absorb the impact caused by the collision of foreign objects.

The soundproof cushioning material formed only of the non-woven fabric made of short fibers, however, has a large surface area due to the voids between the short fibers being exposed on the surface, and thus easily absorbs moisture. Therefore, in winter, the water absorbed in the non-woven fabric freezes, and when the ice on the surface of the non-woven fabric grows in the direction of approaching the tire, the ice interferes with the tire and may adversely affect the steerability of the vehicle.

To prevent this, the soundproof cushioning material disclosed in Patent Document 2 coats the surface of the soundproof cushioning material formed of non-woven fabric with water-resistant film to improve the water resistance and prevent foreign objects from sticking to the material. However, if the surface of the non-woven fabric is completely coated with the water-resistant film in this way, the film will block air. The non-woven fabric then cannot exert the sound-absorbing effect sufficiently.

To solve these problems, Patent Document 3 aims to provide a soundproof cushioning material with excellent impact resistance and soundproofing, as well as excellent ice and water resistance. The soundproof cushioning material is to be mounted on the inner face of the wheel well of a vehicle body, and includes a base layer made of a non-woven fabric in which a large number of short fibers are entangled with each other, and a resin surface layer covering the surface of the base layer. The resin surface layer has a myriad of pores that communicate the base layer and the outside air, has a mass per unit area in the range of 50 to 400 g/m², and contains 60% or more of a molten resin component.

[Patent Document 1] Japanese Unexamined Patent Publication No. 2000-264255

[Patent Document 2] Japanese Unexamined Patent Publication No. 2002-348767

[Patent Document 3] Japanese Unexamined Patent Publication No. 2008-132972

### SUMMARY OF THE INVENTION

The soundproof cushioning material disclosed in Patent Document 3 has insufficient sound absorbing performance because it has a resin surface layer covering the surface of the non-woven fabric. Specifically, although the resin surface layer has a myriad of pores that communicate the base layer and the outside air, sound absorption differs from air absorption. Sounds having a wavelength larger than the pore diameter will be reflected by the resin surface layer and therefore the base layer made of a non-woven fabric in which fibers are entangled with each other does not attenuate (absorb) sounds. Actually Patent Document 3 does not describe the evaluation test results regarding sound absorption.

In view of these problems of the conventional techniques, the present invention aims to provide a manufacturing method of soundproof cushioning material and a soundproof cushioning material with excellent impact resistance and soundproofing, as well as excellent ice and water resistance.

That is, a soundproof cushioning material according to one aspect of the present invention is to be attached to an inner face of a wheel well of a vehicle body, and includes: a soundproof cushioning area, in which a non-woven fabric having a large number of short fibers entangled with each other is disposed; and a continuous resin area defining a continuous face with the soundproof cushioning area with a boundary part intervening therebetween.

A soundproof cushioning material according to another aspect of the present invention is to be attached to an inner face of a wheel well of a vehicle body, and includes: a soundproof cushioning area, in which a non-woven fabric having a large number of short fibers entangled with each other is disposed; and a rib resin area protruding more than a face of the soundproof cushioning area, the rib resin area and the soundproof cushioning area being adjacent to each other with a boundary part therebetween.

A soundproof cushioning material according to another aspect of the present invention is to be attached to an inner face of a wheel well of a vehicle body, and includes: a soundproof cushioning area, in which a non-woven fabric having a large number of short fibers entangled with each other is disposed; a continuous resin area defining a continuous face with the soundproof cushioning area with a boundary part intervening therebetween; and a rib resin area protruding more than a face of the soundproof cushioning area, the rib resin area and the soundproof cushioning area being adjacent to each other with a boundary part therebetween.

A method for manufacturing soundproof cushioning material according to another aspect of the present invention manufactures a soundproof cushioning material to be attached to an inner face of a wheel well of a vehicle body, the soundproof cushioning material including: a soundproof cushioning area including a non-woven fabric having a large number of short fibers entangled with each other; and a resin area defining a continuous face with the soundproof cushioning area with a boundary part intervening therebetween. The method includes compressing the non-woven fabric to apply pressure to a part of the non-woven fabric at a boundary so as to increase a density of the non-woven fabric at the part, thus suppressing inflow of resin for a stable boundary between the soundproof cushioning area and the continuous resin area.

A method for manufacturing soundproof cushioning material according to another aspect of the present invention manufactures a soundproof cushioning material to be attached to an inner face of a wheel well of a vehicle body, the soundproof cushioning material including: a soundproof cushioning area including a non-woven fabric having a large number of short fibers entangled with each other; and a rib resin area protruding more than a face of the soundproof cushioning area, the rib resin area and the soundproof cushioning area having a part of a boundary part therebetween. The method includes compressing the non-woven fabric to apply pressure to a part of the non-woven fabric at a boundary at the soundproof cushioning area so as to increase a density of the non-woven fabric at the part, thus suppressing inflow of resin for a stable boundary between the soundproof cushioning area and the rib resin area.

A method for manufacturing soundproof cushioning material according to another aspect of the present invention manufactures a soundproof cushioning material to be attached to an inner face of a wheel well of a vehicle body, the soundproof cushioning material including: a soundproof cushioning area including a non-woven fabric having a large number of short fibers entangled with each other; a continuous resin area defining a continuous face with the soundproof cushioning area with a boundary part intervening therebetween; and a rib resin area protruding more than a face of the soundproof cushioning area, the rib resin area and the soundproof cushioning area having a part of a boundary part therebetween. The method includes compressing the non-woven fabric to apply pressure to a part of the non-woven fabric at a boundary at the soundproof cushioning area so as to increase a density of the non-woven fabric at the part, thus suppressing inflow of resin for a stable boundary between the soundproof cushioning area and the continuous resin area and/or between the soundproof cushioning area and the rib resin area.

In this way, the soundproof cushioning material of the present invention has a soundproof cushioning area including a non-woven fabric having a large number of fibers entangled with each other, and thus has excellent sound absorption and impact resistance properties. This soundproof cushioning material has a continuous resin area defining a continuous face with the soundproof cushioning area with a boundary part intervening therebetween; and/or a rib resin area protruding more than a face of the soundproof cushioning area, the rib resin area and the soundproof cushioning area having a part of a boundary part therebetween. This enhances the water resistance, and improves the ice and water resistance. In particular, the continuous resin area and the rib resin area are integrally formed, and the rib resin area not only has a protrusion from the continuous resin area, but is located between two sections of the soundproof cushioning area. This gives both of the soundproof cushioning area and the continuous resin area defining the continuous face with the soundproof cushioning area via the boundary part sufficient rigidity. In particular, one section of the rib resin area and another section of the rib resin area intersect to define an intersection. This eliminates anisotropy in rigidity, and gives the soundproof cushioning material as a whole the rigidity in all directions.

The boundary part is a compressed non-woven fabric area that is compressed more than the non-woven fabric of the soundproof cushioning area. This prevents impregnation of resin from the continuous resin area and/or the rib resin area into the non-woven fabric of the soundproof cushioning area during injection molding, and thus keeps high sound absorption property due to the non-woven fabric of the soundproof cushioning area.

Specifically, the compressed non-woven fabric area has a density of three times or more of a density of the soundproof cushioning area. This sufficiently prevents impregnation of resin from the continuous resin area and/or the rib resin area into the non-woven fabric of the soundproof cushioning area during injection molding. If the density of the compressed non-woven fabric area is less than three times that of the soundproof cushioning area, this does not completely prevent the impregnation of resin from the continuous resin area and/or the rib resin area into the non-woven fabric of the soundproof cushioning area during injection molding, and the sound absorption performance will be insufficient in that case. It is not easy industrially to make the density of the compressed non-woven fabric area more than six times higher than that of the soundproof cushioning area, and it also causes higher production cost than necessary.

The non-woven fabric of the soundproof cushioning area extends to a part close to an end of the boundary part near the resin area, and this enables sufficient integrity, continuity, and bonding between the resin area and the soundproof cushioning area.

As described above, the soundproof cushioning material of the present invention has advantageous effects of being excellent in impact resistance and soundproofing, as well as ice and water resistance.

### BRIEF DESCRIPTION OF THE DRAWINGS

FIG. 1 is a partial side view around a wheel well of a vehicle body.

FIG. 2 is a perspective view of a soundproof cushioning material according to one embodiment of the present invention.

FIG. 3 is a schematic partial cross-sectional view of a soundproof cushioning material according to one embodiment of the present invention.

FIG. 4 is another schematic partial cross-sectional view of a soundproof cushioning material according to one embodiment of the present invention.

FIG. 5 is another perspective view of a soundproof cushioning material according to one embodiment of the present invention.

FIG. 6 is another schematic partial cross-sectional view of a soundproof cushioning material according to one embodiment of the present invention.

FIG. 7 is another schematic partial cross-sectional view of a soundproof cushioning material according to one embodiment of the present invention.

FIGS. 8A and 8B illustrate an example of a soundproof cushioning material of the present invention, where FIG. 8A is a photo of the soundproof cushioning material, and FIG. 8B is a perspective view created based on the photo of FIG. 8A.

FIGS. 9A and 9B illustrate the example of a soundproof cushioning material of the present invention at another part, where FIG. 9A is a photo of the soundproof cushioning material, and FIG. 9B is a perspective view created based on the photo of FIG. 9A.

FIGS. 10A and 10B illustrate the example of a soundproof cushioning material of the present invention at another part, where FIG. 10A is a photo of the soundproof cushioning material, and FIG. 10B is a perspective view created based on the photo of FIG. 10A.

FIGS. 11A and 11B illustrate the example of a soundproof cushioning material of the present invention at another part, where FIG. 11A is a photo of the soundproof cushioning material, and FIG. 11B is a perspective view created based on the photo of FIG. 11A.

### DESCRIPTION OF THE PREFERRED EMBODIMENTS

The following describes one embodiment of the present invention, with reference to the drawings.

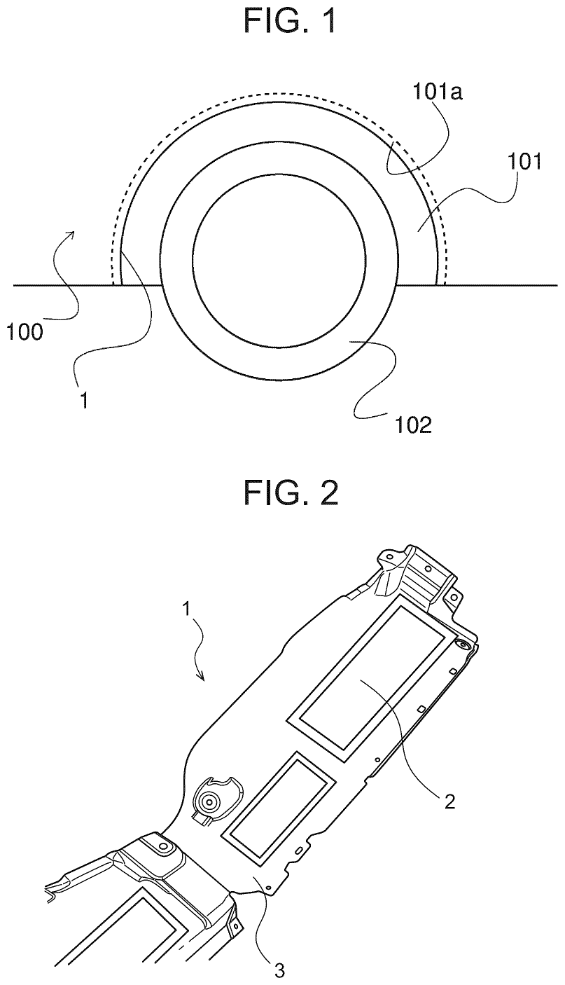

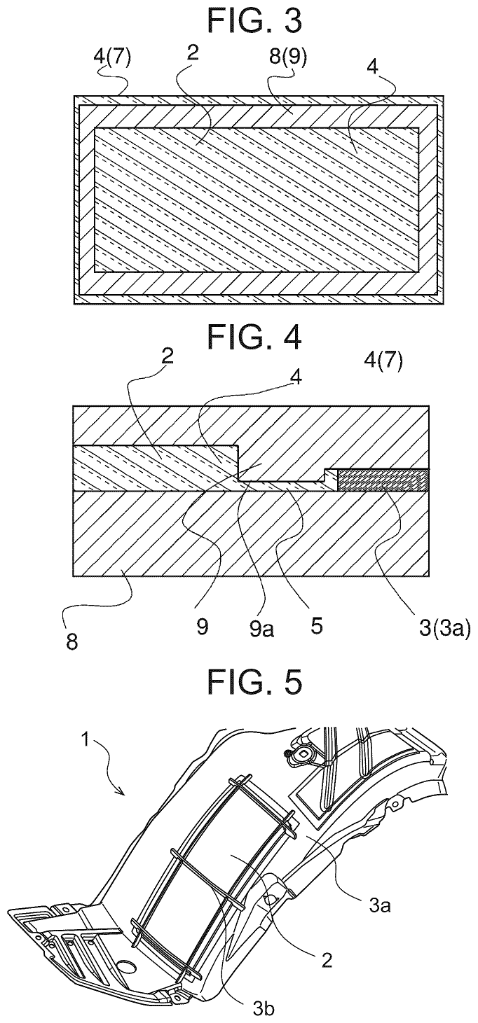

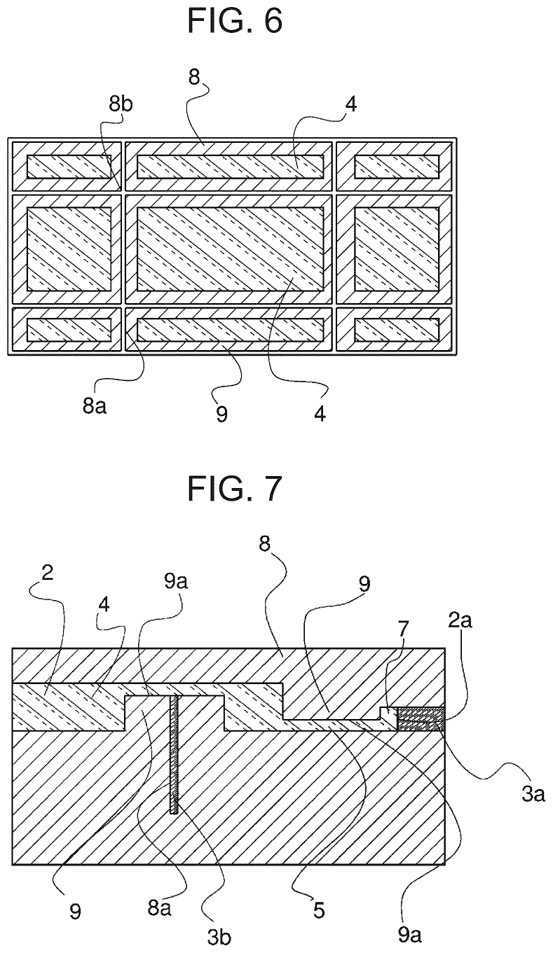

FIG. 1 is a partial side view around a tire 102 of an automobile that is equipped with a soundproof cushioning material 1 according to one embodiment of the present invention. The soundproof cushioning material 1 has a shape along the inner face 101a of a wheel well 101 of a vehicle body 100, and is attached to the inner face 101a.

FIG. 2 and FIG. 5 are schematic perspective views of the soundproof cushioning material 1. This soundproof cushioning material 1 includes a soundproof cushioning area 2 having a top face to be attached to the vehicle body, and a resin area 3 that is placed side by side and adjacent to the soundproof cushioning area 2 to be substantially continuous therewith.

The resin area 3 is prepared by integral injection molding of a continuous resin area 3a illustrated in FIGS. 2 and 5 and a rib resin area 3b illustrated in FIG. 5.

The soundproof cushioning area 2 is configured so that a non-woven fabric 4 having a large number of short fibers entangled with each other is held with the resin area 3 via the boundary part 5 and the soundproof cushioning area 2 is set in tense in an area of the resin area 3. As a result, the resin area 3 is placed side by side and adjacent to the soundproof cushioning area 2 to be substantially continuous with the soundproof cushioning area 2, so that the resin area 3 and the soundproof cushioning area 2 are placed side by side and adjacent to each other to be continuous on the surface of the soundproof cushioning material 1 that faces the tire. Also on the other surface on the opposite side of the surface of the soundproof cushioning material 1 that faces the tire, the other surface of the non-woven fabric 4 with a large number of short fibers entangled with each other is exposed, and the other surface of a continuous resin area 3a, which is placed side by side and adjacent to the other surface of the non-woven fabric 4 to be substantially continuous, is exposed. With this configuration of the soundproof cushioning area 2, both of the surface and the rear face of the soundproof cushioning area 2 are uncovered, so that the sound absorbing ability of the soundproof cushioning area 2 does not reduce due to covering.

In the soundproof cushioning material 1, the non-woven fabric 4 of the soundproof cushioning area 2 internally has myriad of small voids, which give the soundproof cushioning material 1 excellent sound absorption and impact resistance properties. Further, this soundproof cushioning material 1 has the continuous resin area 3a that is placed side by side and adjacent to the soundproof cushioning area 2 to be substantially continuous, and this configuration reduces the water absorption to increase the water resistance, which improves the ice and water proofness. In particular, the resin area 3 may be formed of a hydrophobic resin material, which further improves the water resistance.

The rib resin area 3b protrudes more than a face of the soundproof cushioning area 2, and the rib resin area 3b and the soundproof cushioning area 2 have a part of a boundary part 5 therebetween. This ribbed resin area 3b is prepared to be integral with the continuous resin area 3a by injection molding. The rib resin area 3b is located between two sections of the soundproof cushioning area 2. Further, one section of the rib resin area 3b and another section of the rib resin area 3b intersect to form an intersection 6.

The boundary part 5 includes a compressed non-woven fabric area 4a that is more compressed than the non-woven fabric 4 of the soundproof cushioning area 2 including the non-woven fabric 4 having a large number of short fibers entangled with each other. This compressed non-woven fabric area 4a has a density of three times or more and six times or less that of the soundproof cushioning area 2.

An extension 7 is provided on a part of the boundary part 5 close to the resin area 3. In this extension 7, the non-woven fabric 4 of the soundproof cushioning area 2 extends.

Next, the following describes a manufacturing method of the soundproof cushioning material 1 of one embodiment of the present invention.

First, a die 8 is prepared, having a strip-shaped pressing surface 9a, which is the top face of a convex 9 to form the boundary part 5. The distance between this pressing surface 9a and a face of the die 8 to be opposed to the pressing surface 9a is set about 60 to 80% of the thickness of the resin to be obtained by injection molding. The position of the pressing surface 9a in the die 8 is set inside the outer edge 2a of the soundproof cushioning area 2 to the extent so that the extension 7, in which the non-woven fabric 4 of the soundproof cushioning area 2 extends, is set on the resin area 3.

The die 8 also has an area 8a to form the rib resin area 3b. This area 8a to form the rib resin area is placed so that the rib resin area 3b is formed between two sections of the soundproof cushioning area 2. The area 8a to form the rib resin area is formed vertically and horizontally, resulting in the formation of a rib resin forming area intersection 8b where one section of the rib resin forming area 8a intersects with another section of the rib resin forming area 8a.

A non-woven fabric 4 having a large number of short fibers entangled with each other is placed in the above die 8. The non-woven fabric 4 is placed so that, when the die 8 is set in a predetermined position before receiving resin for injection, the non-woven fabric 4 covers the strip-shaped pressing surface 9a, which is the top face of the convex 9 to form the boundary part 5, and the outer edge of the non-woven fabric 4 extends outside of the pressing surface 9a. This forms the extension 7 on the resin area 3 where the non-woven fabric 4 of the soundproof cushioning area 2 extends.

Then resin is injected into the die 8 in this state, whereby the soundproof cushioning material 1 according to one embodiment of the present invention can be obtained. Specifically, the resin injected into the die 8 is blocked by the boundary part 5, which is formed by the strip-shaped pressing surface 9a, and does not enter the soundproof cushioning area 2, and the continuous resin area 3a and the rib resin area 3b are formed. This prevents deterioration of the sound absorbing ability of the soundproof cushioning area 2 due to the impregnation of the resin. The extension 7 is formed in the resin area 3, where the non-woven fabric 4 of the soundproof cushioning area 2 extends. This extension 7 keeps the continuity between the soundproof cushioning area 2, the continuous resin area 3a, and the rib resin area 3b, whereby the soundproof cushioning material 1 obtained is integral.

### EXAMPLE 1

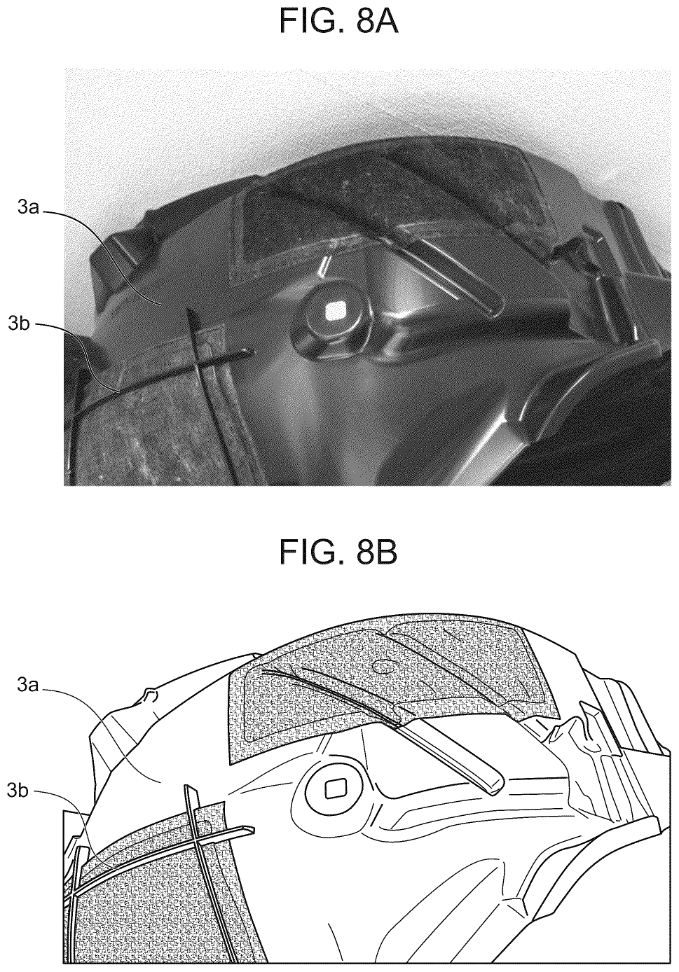

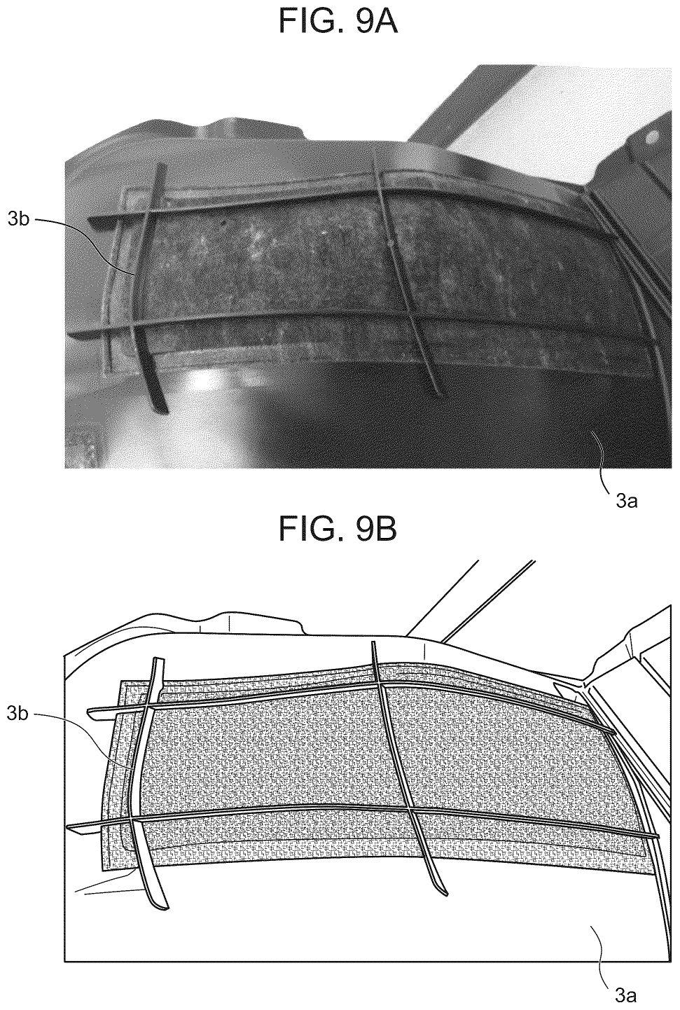

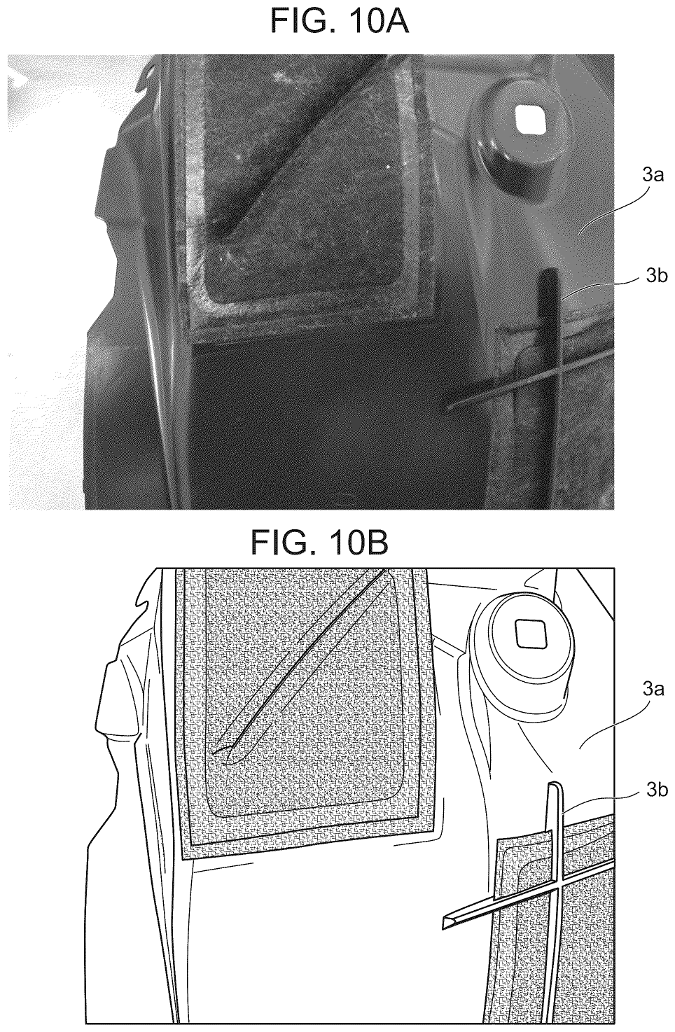

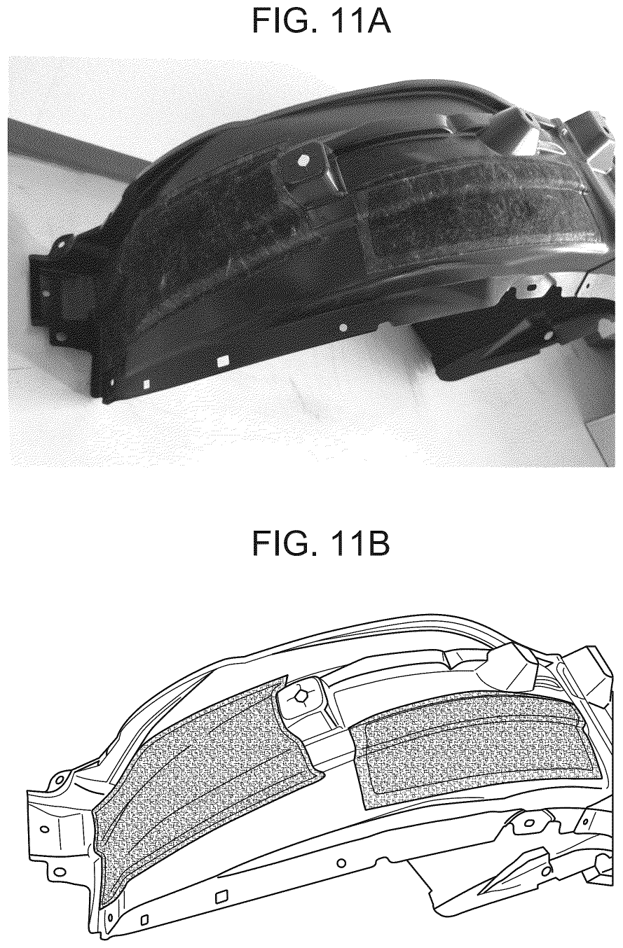

To confirm the usefulness of the present invention, the soundproof cushioning material 1 according to the present invention was prepared. This soundproof cushioning material 1 had the continuous resin area 3a having a continuous face with the soundproof cushioning area 2 made of the non-woven fabric 4 with the boundary part 5 intervening therebetween, and the rib resin area 3b. FIGS. 8A to 11B illustrate photographs of the soundproof cushioning material 1 (Example).

### DESCRIPTION OF REFERENCE SIGNS

1 . . . Soundproof cushioning material, 3 . . . Resin area, 2 . . . Soundproof cushioning area, 4 . . . Non-woven fabric, 7 . . . Extension, 3b . . . Rib resin area, 5 . . . Boundary Part, 9a . . . Pressing surface, 8 . . . Die

This application is based on Japanese Patent Application No. 2021-40038 filed Mar. 12, 2021, the disclosure of which is incorporated herein by reference in its entirety.

What is claimed is:

1. A method for manufacturing a soundproof cushioning material to be attached to an inner face of a wheel well of a vehicle body, the soundproof cushioning material including: a soundproof cushioning area including a non-woven fabric having a large number of short fibers entangled with each other; a continuous resin area defining a continuous face with the soundproof cushioning area with a boundary part intervening therebetween; and a rib resin area protruding more than a face of the soundproof cushioning area, the rib resin area and the soundproof cushioning area having a part of a boundary part therebetween, the method comprising:
compressing the non-woven fabric to apply pressure to a part of the non-woven fabric at a boundary at the soundproof cushioning area so as to increase a density of the non-woven fabric at the part, thus suppressing inflow of resin for a stable boundary between the soundproof cushioning area and the continuous resin area and/or between the soundproof cushioning area and the rib resin area.
